(19) United States
(12) Patent Application Publication
(10) Pub. No.: US 2017/0090103 A1
(43) Pub. Date: Mar. 30, 2017

(54) ILLUMINATION SYSTEM WITH OVERLAPPING LIGHT GUIDING UNITS

(71) Applicant: QUALCOMM MEMS Technologies, Inc., San Diego, CA (US)

(72) Inventor: Robert Louis Holman, San Jose, CA (US)

(21) Appl. No.: 14/920,441

(22) Filed: Oct. 22, 2015

Related U.S. Application Data
(60) Provisional application No. 62/233,171, filed on Sep. 25, 2015.

(51) Int. Cl. F21V 8/00

(52) U.S. Cl. CPC G02B 6/0061; G02B 6/0076; G02B 6/003; G02B 6/0065

(57) ABSTRACT

This disclosure provides systems, methods and apparatus for illumination. In one aspect, an illumination system includes at least two partially overlapping light guiding units. Each light guiding unit includes an optical source, an optical coupling system, and a tapered light guide. The two light guiding units are disposed such that the tapered light guide of one light guiding unit at least partially overlaps the optical coupling system of an adjacent light guiding unit.

### CROSS-REFERENCE TO RELATED APPLICATIONS

This disclosure claims priority to U.S. Provisional Patent Application No. 62/233,171, filed on Sep. 25, 2015, entitled “ILLUMINATION SYSTEM WITH OVERLAPPING LIGHT GUIDING UNITS,” and assigned to the assignee hereof. The disclosure of the prior application is considered part of, and is incorporated by reference in, this disclosure.

### TECHNICAL FIELD

This disclosure relates to illumination devices utilizing light guides.

### DESCRIPTION OF THE RELATED TECHNOLOGY

Various luminaire products available in the market, such as recessed troffers, suspended downlights, suspended up-lights, hidden cove lights, recessed wall grazers and recessed or suspended wall-washers, utilize linear distributions of optical sources that are disposed along the length of the luminaire products, which can range from about 1 foot to several feet. The luminaire can include diffusers and/or reflectors. Many luminaire products currently available may be thick, heavy and/or bulky. Additionally, the luminaire products may not be capable of providing illumination having high brightness and color uniformity. Accordingly, there is a need for thin-profile luminaire products capable of outputting light with high brightness and uniformity.

### SUMMARY

The systems, methods and devices of the disclosure each have several innovative aspects, no single one of which is solely responsible for the desirable attributes disclosed herein.

One innovative aspect of the subject matter described in this disclosure can be implemented in an illumination system comprising a plurality of partially overlapping light guiding units, an optical source and an optical coupling system. Each light guiding unit includes a tapered light guide having a light input edge and an output surface disposed at an angle with the light input edge. A surface of the tapered light guide opposite the output surface is angled at a taper angle α with respect to the output surface. The optical coupling system is configured to couple light from the optical source into the light input edge. The plurality of light guiding units are staggered such that the tapered light guide of one of the plurality of light guiding units at least partially overlaps the optical coupling system of an immediately adjacent light guiding unit. The optical source can include a plurality of light emitting diodes.

In various implementations, the optical coupling system can be disposed immediately adjacent the light input edge of the tapered light guide. The optical coupling system can include a light collimating section having a light input surface and a light output surface. The light collimating section can be configured to emit collimated light from the light output surface towards the light input edge of the tapered light guide. The side walls of the light collimating section between the light input surface and the light output surface can be configured to collimate light in the plane of the output surface of the tapered light guide. The light collimating section can be configured to preserve etendue of the light from the light input surface to the light output surface. The optical coupling system can further include a light mixing section having a refractive index (n). The light mixing section can include a light receiving surface configured to receive light from the optical source. Light output from the light mixing section can be coupled into the light collimating section. The optical source can be separated from the light receiving surface of the light mixing section by a gap, wherein the gap comprises a material having lower refractive index than the refractive index (n) of the light mixing section. In various implementations, the light mixing section can be a rectangular light pipe. In various implementations, a lenticular array can be disposed between the light output surface of the collimating section and the light input edge of the tapered light guide. One or more light extraction features can be disposed along the light output surface of the tapered light guide. The optical coupling system can be angled with respect to the light input edge of the tapered light guide by an angle greater than or equal to the taper angle α.

Another innovative aspect of the subject matter described in this disclosure can be implemented in a light guiding unit comprising a tapered light guide and an optical coupling system. The tapered light guide includes a light input edge and an output surface disposed at an angle to the light input edge, a surface of the tapered light guide opposite the output surface is angled at a taper angle α with respect to the output surface. The optical coupling system include a light mixing section having a refractive index (n) and a light collimating section. The light mixing section includes a light receiving surface configured to receive light from an optical source. The light collimating section has a light input surface and a light output surface. The light collimating section is configured to receive light output from the light mixing section through the light input surface and emit collimated light towards the light input edge of the tapered light guide from the light output surface. The side walls of the light collimating section between the light input surface and the light output surface are configured to collimate light in the plane of the output surface of the tapered light guide.

In various implementations, the light collimating section can be configured to preserve etendue of the light from the light input surface to the light output surface. The optical source can be spaced apart from the light receiving surface of the light mixing section by a gap, wherein the gap comprises a material having lower refractive index than the refractive index (n). In various implementations, the light mixing section can be a rectangular light pipe. The optical source can comprise a plurality of light emitting diodes. In various implementations of the light guiding unit, a lenticular array can be disposed between the light output surface of the collimating section and the light input edge of the tapered light guide. The light mixing section can have a length that is configured to spatially mix light emitted from the optical source. In various implementations, the light mixing section can have a length that is configured to angularly mix light emitted from the optical source.

Another innovative aspect of the subject matter described in this disclosure can be implemented in a method of fabricating an illumination system. The method comprises providing a plurality of light guiding units. Each light guiding unit includes an optical source, a tapered light guide and an optical coupling system. The tapered light guide has a light input edge and an output surface disposed at an angle with the light input edge. A surface of the tapered light guide opposite the output surface is angled at a taper angle α with respect to the output surface. The optical coupling system is configured couple light into the light input edge. The method further comprises disposing the plurality of light guiding units such that the tapered light guide of one of the plurality of light guiding units at least partially overlaps the optical coupling system of an immediately adjacent light guiding unit. In various implementations, the optical coupling system can be disposed at an angle with respect to the light input edge of the tapered light guide. The angle between the optical coupling system and the light input edge of the tapered light guide can be greater than or equal to the taper angle α.

In various implementations, the optical coupling system can include a light collimating section having a light input surface and a light output surface. The light collimating section can be configured to emit collimated light towards the light input edge of the tapered light guide from the light output surface. The side walls of the light collimating section between the light input surface and the light output surface can be configured to collimate light in the plane of the output surface of the tapered light guide. The optical coupling system can also include an additional light mixing section having a refractive index (n). The light mixing section can include a light receiving surface configured to receive light from the optical source. The light mixing section can be configured to spatially and/or spectrally mix input light from the optical source. The light mixing section is configured to couple light into the light collimating section.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Example implementations disclosed herein are illustrated in the accompanying schematic drawings, which are for illustrative purposes only and do not limit the invention.

FIG. 1A-1 and FIG. 1A-2 illustrate an example of a lighting system including a plurality of partially overlapping light guiding units, with one unit partially overlying another unit.

FIG. 1B is a cross-sectional view of an example of a tapered light guide including the light input surface, a light output surface and an inclined surface opposite the light output surface.

FIG. 1C illustrates a cross-sectional view of an example of a light guiding unit including the tapered light guide of FIG. 1B and an optical coupling system.

FIG. 1D illustrates a perspective top-view of an example of a light guiding unit including the tapered light guide of FIG. 1B and an optical coupling system.

FIG. 2A illustrates an example of an optical coupling system including an etendue-preserving angle transformer provided at the input end of the mixing section.

FIG. 2B illustrates an example of an optical coupling system including an etendue-preserving angle transformer provided at the output end of the collimating section.

FIG. 3 illustrates an example of the tapered light guide including a lenticular array including a plurality of lens elements disposed adjacent the light input surface of the tapered light guide.

FIG. 4 is a flowchart that illustrates an example of a method of fabricating an illumination system including a plurality of partially overlapping light guiding units.

Like reference numbers and designations in the various drawings indicate like elements.

### DETAILED DESCRIPTION

The following detailed description is directed to certain implementations for the purposes of describing various innovative aspects. However, the teachings herein can be applied in a multitude of different ways. As will be apparent from the following description, the innovative aspects may be implemented in any device that is configured to provide illumination. More particularly, it is contemplated that the innovative aspects may be implemented in or associated with a variety of applications such as commercial or residential lighting. Implementations may include but are not limited to lighting in homes, offices, schools, manufacturing facilities, retail locations, restaurants, clubs, hospitals and clinics, convention centers, hotels, libraries, museums, cultural institutions, government buildings, warehouses, military installations, research facilities, gymnasiums, sports arenas, backlighting for displays, signage, billboards or lighting in other types of environments or applications. Additionally, illumination systems including various implementations of partially overlapping light guiding units described herein can be incorporated in or used as a building material, such as, for example, as parts of walls, floors, and/or ceilings of residential and commercial structures. Other uses are also possible. Thus, the teachings are not intended to be limited to the implementations depicted solely in the Figures, but instead have wide applicability as will be readily apparent to one having ordinary skill in the art.

As discussed more fully below, various implementations described herein include illumination systems comprising a plurality of overlapping light guiding units, each of which includes a light guide coupled to an optical source (a source of optical radiation) via an optical coupling system. Advantageously, the overlapping light guiding units may provide a thin profile and high brightness and color uniformity.

The optical source may include one or more discrete optical sources (e.g., light emitting diode, or LED, emitters). In various implementations, the optical source can output multiple colors, e.g. the optical source may include multi-color LED arrays (e.g., red, green, blue, amber and white LEDs). The illumination systems described herein include at least two partially overlapping light guiding units. Each light guiding unit includes an optical coupling system and a tapered light guide. The optical coupling system can include a light receiving surface associated with an input aperture that is configured to receive light emitted from the optical source and a light output surface associated with an output aperture that is configured to emit the received light towards the light guide. The optical coupling system is configured to receive light from the optical source through the input aperture and inject light into a light input edge of the tapered light guide through the output aperture. The light guiding units partially overlap such that the tapered light guide of a first one of at least two light guiding units is disposed over the optical coupling system of a second one of the at least two light guiding units. However, the tapered light guide of one light guiding unit does not overlap with the tapered light guide of an adjacent light guiding unit. Accordingly, the tapered light guides of the plurality of light guiding units can be arranged sequentially such that light from the illumination system is emitted from a plurality of serially sequential tapered light guides.

In various implementations, the optical coupling system can be tilted with respect to the input edge of the tapered light guide by an angle equal to or greater than the taper angle of the tapered light guide. Such implementations can be configured to be thin, light weight and/or have slim profiles. In various implementations, the optical coupling system can be a two-stage coupler comprising a mixing section and a collimating section. The mixing section can have a length that spatially mixes light emitted from the optical source. In some implementations, the mixing section can be configured to mix or homogenize (spatially and/or angularly) the light output from the optical source. For example, the output from an array of LEDs that emit light of different wavelengths (e.g., white, red, blue, lime green, and amber) can be mixed or homogenized by the collective action of the optical coupling system to reduce color non-uniformity.

The collimating section can have a length and a shape such that etendue of light input into the collimating section is preserved at the output of the collimating section and light is collimated in the plane of the collimating section. In various implementations, the collimating section and the tapered light guide can be coplanar. In such implementations, the collimating section can be configured to collimate light in the plane of the light output surface of the tapered light guide. In various implementations, a light extracting component may be included along the light output surface of the tapered light guide. The light extracting component can include scattering, reflecting, diffusing and/or light redirecting elements that can extract light propagating inside the tapered light guide. In various implementations, a light spreading component can be disposed at the light input edge of the tapered light guide. The light spreading component can include a lenticular array whose lenslets spread light in a plane orthogonal to the plane of the light output surface of the tapered light guide. The light spreading component can advantageously increase the light acceptance angle of the tapered light guide.

The optical coupling system may also facilitate coupling between the optical source and the light guide by better matching an output aperture of the optical source to an input aperture of the light guide. For example, in various implementations the input aperture of the light guide can be smaller than the physical dimensions of the array of LEDs by a factor equal to approximately the square of the refractive index of the light guide. In such implementations, the optical coupling system can be configured to couple light from the larger output aperture of the optical source to the smaller input aperture of the light guide without sacrificing etendue. To facilitate this, in various implementations, the input aperture and the output aperture of the optical coupling system can be configured to have a size that is equal to or smaller than a size of the output aperture of the optical source. It is noted that although the input aperture of the optical coupling system can be smaller than, larger than or have the same size as the output aperture of the optical source, flux efficiency is increased when the size of the output aperture of the optical source is smaller than or matched to the size of the input aperture. However, making the size of the output aperture of the source smaller than the size of the input aperture of the optical coupling system can be detrimental to preserving etendue, which may be undesirable in various applications. The size of the output aperture of the optical coupling system can be smaller than the size of the output aperture of the optical source by a factor equal to approximately the square of the refractive index of the material of the optical coupling system. The size of the output aperture of the optical coupling system can be matched (e.g., less than or equal to) the size of the input aperture of the light guide. Additionally, to increase coupling efficiency, the refractive index of the material of the light guide can be equal to or substantially the same as the refractive index of the optical coupling system, e.g., the refractive index of the material forming the optical coupling system is selected to be as close as possible to that the refractive index of the light guide. For example, the refractive index of the material forming the light guide can be equal to the refractive index of the material forming the optical coupling system±0.01. When the refractive indices of the optical coupling system and the light guide are not substantially the same, Fresnel reflections can occur at the interface between the optical coupling system and the light guide, which can lower the coupling efficiency. The Fresnel reflections can become more pronounced as the angle of incidence measured from the normal to the interface increases.

Particular implementations of the subject matter described in this disclosure can be implemented to realize one or more of the following potential advantages and functionalities. In some implementations, illumination systems including partially overlapping light guiding units can be configured to be light weight, compact, and/or have a slim profile. As disclosed herein, the output aperture of the optical coupling system can be configured to have a size that is equal to or less than the size of the input aperture of the light guide so as to efficiently couple light from the optical source into the light guide. Certain implementations of optical coupling systems described herein can advantageously decrease the effective aperture of the optical source to match the input aperture of the light guide to which the optical source is coupled without sacrificing the brightness of the optical source. Accordingly, the systems described herein can be configured to have high optical coupling efficiency. Furthermore, the implementations of optical coupling systems described herein can reduce non-uniformities in color and/or intensity at the input aperture of the light guide and/or in the near field and far field radiation pattern of light emitted from the output aperture of the light guide.

The use of the light guides and overlapping arrangement described herein allow for flexibility in the overall shape and size of the illumination system and in the characteristics of the light output from the system. Some implementations disclosed herein include thin, e.g., plate-like, illumination systems (also, luminaires, illumination devices, lighting devices, and lighting fixtures) that can output light beams with light distribution patterns that have a square, rectangular, circular, or some other cross-sectional shape. The light from the output light beams can be distributed uniformly over enlarged output apertures of reduced brightness. In some implementations, such uniformity is achieved while the light output remains sharply defined and well-directed from +/−5- to +/−60 degrees in each meridian, including all asymmetric combinations in between. Various implementations described herein can advantageously provide smoothly-mixed full-spectrum color illumination with angular distributions that can satisfy a wide range of general lighting services, including wide area lighting, spot lighting, flood lighting, task lighting, and wall washing (or grazing).

In some implementations, the illumination system can be sized and/or shaped to fit within the recess of a standard lighting fixture, for example, a recess for a parabolic aluminized reflector (“PAR”) fixture. In some other implementations, the illumination systems can be differently sized and/or shaped than a standard lighting fixture recess such that the light guide does not fit within the recess or such that the light guide fits in the recess with clearance on one or more sides. In other cases, the illumination systems can be configured with their own packaging serving as a lighting fixture, such as in the case of various forms of suspended downlights.

In some implementations, the illumination systems can include commercial LED emitters with heat extraction structures, associated optical coupling systems, associated light distributing optics, and optional light spreading elements. Further, some implementations disclosed herein can include electronics (e.g., low voltage DC power control electronics, as well as various microprocessors, transmitters, receivers, and sensors). In some implementations, the illumination systems may be configured as packaged sources of far-field illumination whose total package cross-sectional thickness is less than about 1-inch. Additionally, in some implementations, the illumination systems can be adapted to dilute the LED's high brightness levels, without losing other favorable lighting characteristics, such as tightly controlled beams of illumination and well-defined illumination patterns, so as to provide lighting fixtures with less aperture glare.

In some implementations, the illumination systems disclosed herein can be compact in their physical size. For example, the size of various implementations of lighting systems and luminaire's disclosed herein disclosed herein can be between approximately 2.5 inches×2.5 inches. In other forms they can be 2 inches×12 inches or 2 inches×24 inches. Implementations of optical coupling systems and light guides disclosed herein can have small cross-sectional thickness. For example, the thickness of optical coupling systems and light guides themselves can be between approximately 3-10 mm. Although, in certain practical applications that are not constrained by overall thickness, the illumination systems can be substantially thicker. Additionally, the light output from the optical source, the optical coupling systems and light guides coupled to the optical coupling systems is not limited by the physical size of the optical source, the optical coupling systems and/or the light guides and can range from hundreds of lumens per luminaire to thousands. In various implementations, the resulting output illumination can be constrained to beams organized as tightly as +/−5 degrees, as broadly as +/−60 degrees, or as any asymmetric combination in between. The beams that are output from the illumination systems and luminaire's disclosed herein can have a sharp enough angular cutoff to reduce off-angle glare (i.e., veiling glare) along with the spatially-even square, rectangular and circular far-field illumination patterns sought by lighting architects and users alike. Advantageously, in various implementations, illumination systems have their total output lumens spread over the system's enlarged output apertures so as to reduce aperture brightness, and thereby reduce disability glare to viewers who happen to look within the illumination system's far-field beam itself.

Due to the thinness that may be achieved, various implementations of illumination systems described herein may be integrated within the physical body thickness of common building materials (as are used in forming commercial ceilings and walls), electrically interconnected, and electronically controlled (individually and as an interconnected distribution).

The above noted and other details are described with reference to various figures below.

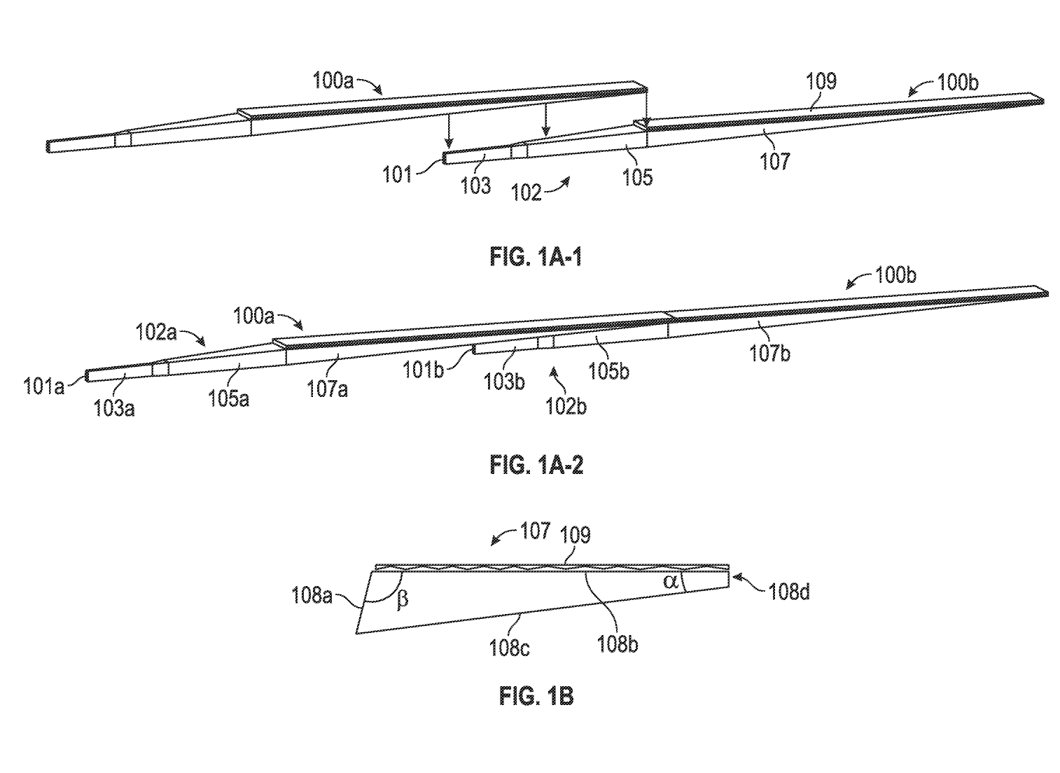

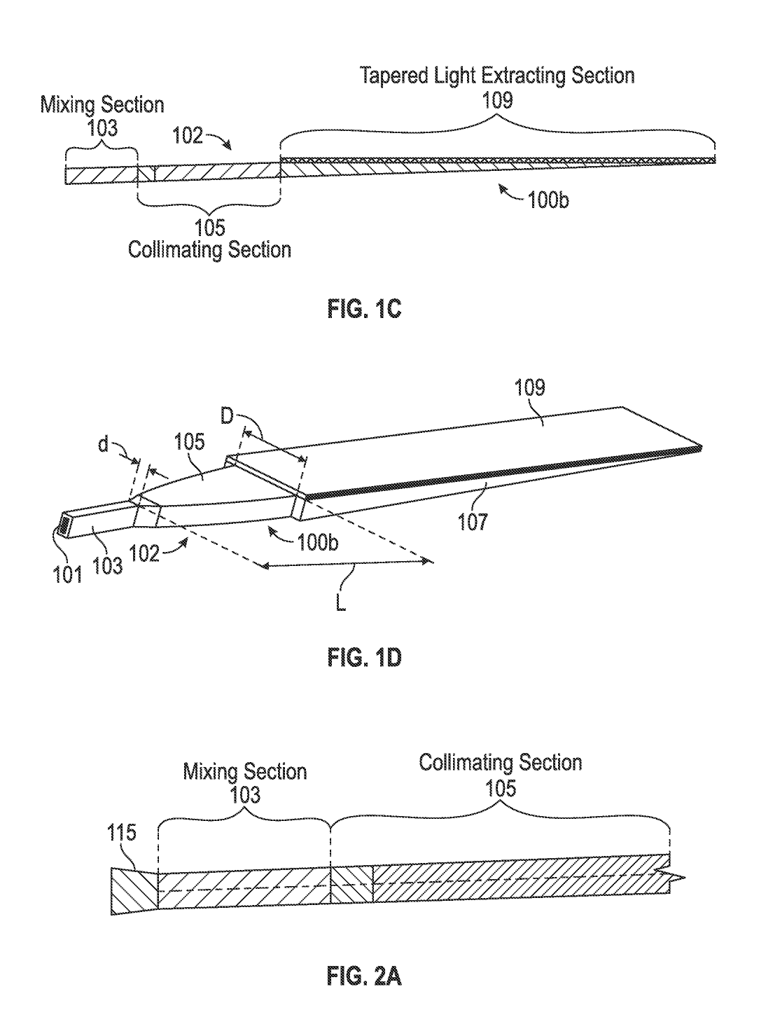

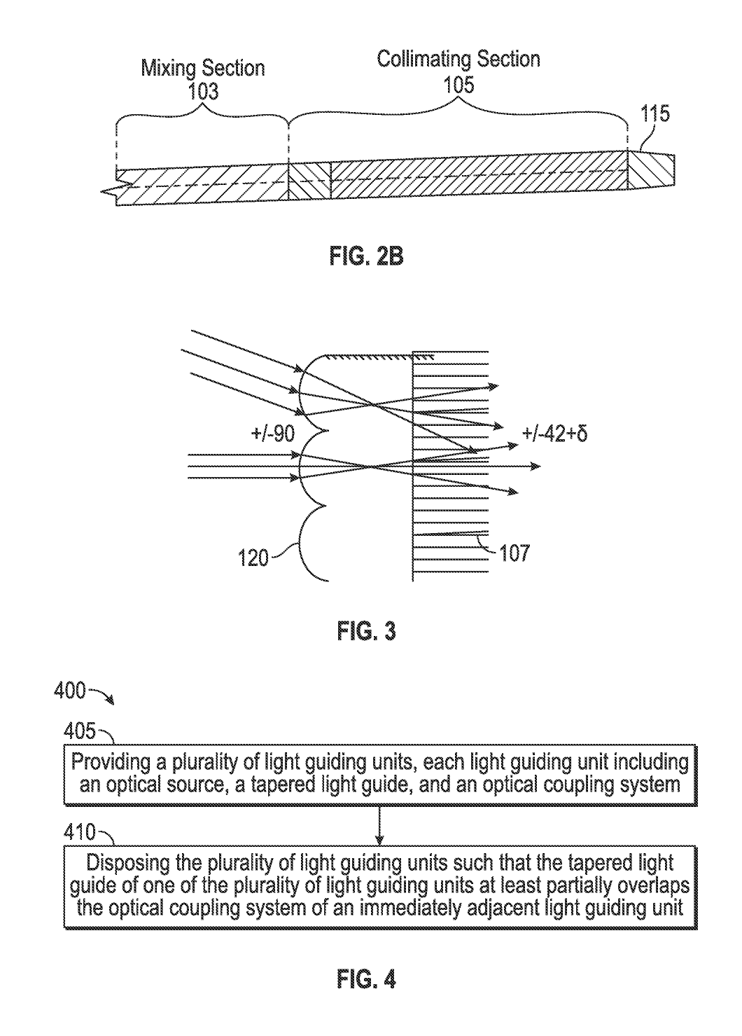

FIGS. 1A-1 and 1A-2 illustrate an example of a lighting system including a plurality of partially overlapping light guiding units 100a and 100b, with one unit partially overlying another unit. Additional light guiding units can be provided, thereby forming a continuous row of partially overlapping light guiding units. For example, in some implementations, the illumination systems include more than 2 and less than 1000 light guiding units (e.g., between 3 and 10 light guiding units, between 5 and 20 light guiding units, between 10 and 50 light guiding units, between 20 and 100 light guiding units, between 30 and 150 light guiding units, between 50 and 200 light guiding units, between about 100 and 500 light guiding units, between about 250 and 750 light guiding units, between about 500 and 1000 light guiding units or values there between). Each light guiding unit (e.g., 100a and 100b) includes a tapered light guide 107 having a light input surface 108a and an optical coupling system 102. The optical coupling 102 is configured to couple light from an optical source 101 into the light input surface 108a of the tapered light guide 107.

The optical source 101 can include one or more LEDs. In various implementations, the one or more LEDs can be substantially monochromatic emitters that emit light having a single wavelength. In various implementations, the optical source 101 can include LEDs that can emit light with different wavelengths, e.g., wavelengths corresponding to different colors which may be mixed to provide “white” light or light including a plurality of wavelengths that are homogeneously-mixed. In some implementations, the optical source 101 includes an array of LEDs that includes groups of LEDs, with each group emitting light of a different wavelength. The one or more LEDs in the optical source 101 can be disposed on a substrate that provides electrical power to the one or more LEDs. The substrate can also include heat sinks to dissipate heat. The optical coupling system 102 is configured to be coupled to the optical source 101 such that the optical coupling system 102 is spaced apart from the optical source 101 device by a gap. The gap can be filled with a material having a lower refractive index than the material of the optical coupling system 102. For example, the gap between the optical source 101 and the optical coupling system 102 can include air. In various implementations, the optical source 101 can include one or more optical components disposed over the one or more LEDs. For example, the optical source 101 can include a hemispherical dome lens having a diameter D disposed over the one or more LEDs, which may be accommodated within the optical coupling system by correspondingly shaped receptacles for the hemispherical dome lenses. As another example, a reflective element may be disposed around the one or more LEDs to reduce optical loss. As yet another example, the LED's output aperture plane may be abutted directly against the edge of the optical coupling system.

Although various implementations disclosed herein include semiconductor light emitting diodes (or LEDs) this disclosure contemplates the use of other light emitting devices such as, for example, organic LEDs (also referred to as OLED), thin flat fluorescent sources, semiconductor laser diodes and flat micro plasma discharge sources, to mention a few. Such other light emitting devices may be utilized in place of, or in conjunction with, the LEDs described herein.

FIG. 1B is a cross-sectional view of an example of a tapered light guide 107 including the light input surface 108a, a light output surface 108b and an inclined surface 108c opposite the light output surface 108b. The inclined surface 108c and the light output surface 108b can be oriented with respect to each other such that an angle α is included between those surfaces. Accordingly, the tapered light guide 107 can be configured as a wedge. The light input surface 108a and the light output surface 108b can be disposed at an angle β with respect to each other. The angle β between the light input surface 108a and the light output surface 108b can be 90 degrees, greater than 90 degrees or less than 90 degrees. The thickness of the tapered light guide 107 at the periphery 108d can be less than the thickness of the light guide 107 at the light input surface 108a. In some implementations, the thickness of the light guide 107 at the periphery 108d can be such that the periphery 108d forms a knife-edge whose thickness is substantially less than 10% of the cross-sectional thickness at the light input surface 108a. In some implementations, the thickness of the periphery 108d can be as small a fraction of the thickness at the light input surface 108a as is feasible to manufacture, which may be, for example less, than or equal to 100 μm. In various implementations, the thickness of the periphery 108d can be less than or equal to about 50 μm or less than or equal to about 25 μm.

The angle α between the light output surface 108b and the inclined surface 108c can be greater than about 1 degree and less than about 15 degrees, for example, between about 2 degrees and about 8 degrees (including 2 degrees, 3 degrees, 4 degrees, 5 degrees, 6 degrees, 7 degrees, 8 degrees, or any value between any two of these values). In some implementations, angle α between the light output surface 108b and the inclined surface 108c can be less than about 1 degree. However, the output efficiency can drop significantly as angle α falls progressively further below about 1 degree. In this way, a maximum longitudinal dimension of the tapered light guide 107 (along a direction that is normal to the light output surface 108b) can be relatively thin, for example, less than 50 mm or 2 inches. However, depending upon the taper angle α and the length of the tapered light guide 107, tapered light guides with longitudinal dimensions between about 1 mm and about 16 mm, for example, or between about 2 mm and 6 mm, can be provided.

The light input surface 108a and the light output surface 108b can be planar in various implementations. The light guide 107 can include a material having a refractive index n_{guide}. In various implementations, the light guide 107 can include optically transparent materials such as, for example PMMA, glass, polycarbonate, ZEONEX™, acrylic or any other optical grade polymeric material. The tapered light guide 107 can include one or more light extraction features 109 that are disposed adjacent to the light output surface 108b and are configured to extract light propagating within the light guide 107. In some implementations, the light extraction features 109 may be diffractive and/or reflective features, including diffractive gratings, holograms, and/or reflective structures having facets.

Operationally, light injected into the tapered light guide 107 through the light input surface 108a propagates along the tapered light guide 107 through multiple total internal reflections between the light output surface 108b and the inclined surface 108c of the tapered light guide 107. Light is extracted into air by failure of total internal reflection within the tapered light guide at one or both the light output surface 108b and the inclined surface 108c. The extracted light exits out of the tapered light guide 107 along the length of one or both the light output surface 108b and the inclined surface 108c in a narrow angular range inclined at a relatively small angle to the plane of the light output surface 108b or the inclined surface 108c of the tapered light guide. The light extraction features 109 disposed adjacent the light output surface 108b of the tapered light guide 107 are configured to extract light out of the medium surrounding the tapered light guide 107 and redirect that light at a desired angle. For example, the light extraction features 109 can be configured to redirect light that exits the tapered light guide 107 along a direction that is generally orthogonal to the plane of the light output surface 108b or the plane of the inclined surface 108c. As further described below, the optical coupling system 102, the optical source 101 and the light guide 107 can be configured such that light extracted from the tapered light guide 107 is uniformly bright and does not have any regions of darkness or reduced brightness.

The optical coupling system 102 can be configured to (i) receive light from the optical source 101, which can have multiple discrete light emitters that, in the aggregate, emit multicolored light (e.g., a multicolored array of LED emitters); (ii) spatially mix the multicolored light; and (iii) collimate the light in one meridian. For example, the optical coupling system 102 can be configured to collimate light in the plane of the light output surface 108b of the tapered light guide 107. In some implementations, the optical coupling system 102 can be a two-stage coupler, having a mixing section configured to spatially mix light emitted from the optical source and a collimating section for collimating the spatially mixed light (or homogenized light). In some other implementations, the mixing section and the collimating section need not be distinct; that is, mixing and collimation of the light may occur together. This is possible as collimation only occurs in one meridian, the plane of the light output surface of the tapered light guide 107 (alternately, the plane of the collimating section 105). In a plane orthogonal to the plane of the collimating section 105, the input light propagates along the length collimating section 105 by successive bounces due to total internal reflection from the upper and bottom surfaces of the collimating section 105. The successive bounces can cause some degree of spatial and color mixing in the light output from the collimating section 105. The degree of color mixing can be increased by including a separate mixing section 103 that can provide additional spatial and color mixing.

FIG. 1C illustrates a cross-sectional view of an example of a light guiding unit 100b including the tapered light guide 107 of FIG. 1B and an optical coupling system 102. FIG. 1D illustrates a perspective top-view of an example of a light guiding unit 100b including the tapered light guide 107 and an optical coupling system 102. The optical coupling system 102 illustrated in FIGS. 1C and 1D is a two-stage coupler including a mixing section 103 and a collimating section 105. The two-stage coupler is configured to receive light from the optical source 101. As discussed herein, in various implementations, the source 101 can include an array of multicolored LEDs. In various implementations, the source 101 can be spaced apart from the optical coupling system 102 (the mixing section 103 of the optical coupling system 102, as illustrated) by an air gap.

In the illustrated implementation, the mixing section 103 is a rectangular pipe having an output aperture with a width d. The collimating section 105 has a light input surface that has substantially the same size and shape as the light output surface of the mixing section 103. The collimating section 105 fans out from the mixing section 103 such that the width of the output aperture of the collimating section 105 at a length L has a width D. In the illustrated implementations, the cross-sectional shape of the collimating section 105 is rectangular (as viewed along a plane transverse to the length of a collimating section 105). In various other implementations, the cross-section of the mixing section 103 and the collimating section 105 can be square, circular, oval or some other polygonal shape.

The length of the mixing section 103 is configured to spatially mix light output from the optical source 101. For example, in various implementations, the mixing section 103 can have a length between about 15 mm and about 100 mm. Without being limited by theory, it will be appreciated that degree that mixing increases with increasing length. In some implementations, the length is selected to achieve a desired degree of spatial mixing. For example, a length of the mixing section 103 can be configured such that light emitted in a plurality of wavelengths and/or angles from the optical source 101 is spatially homogenized due to a multiplicity of total internal reflection bounces. The degree of spatial and color mixing can be sufficient such that a human visual system can perceive an evenness of color in the near field of the tapered light guide 107 and/or in the beam pattern that occurs on a wall or ceiling. The mixing efficiency of the mixing section 103 can depend on the orientation of the LED array in the optical source 101, the spatial arrangement of different colored LEDs in the LED array and/or the order of firing the LEDs in the LED array. For example, changing the orientation of the LED array from vertical (i.e., LED array orientated along the height of the light input surface of the mixing section 103) to horizontal (i.e., LED array orientated along the width of the light input surface of the mixing section 103), while all other parameters remain the same can degrade spatial and/or color uniformity. Increasing the length of the mixing section 103 can improve spatial and/or color non-uniformity in cases where the orientation of LED array results in output with spatial and/or color non-uniformity.

In some implementations, spatial and/or color non-uniformity can also be improved by locating and firing discrete light sources symmetrically with respect to a center axis of the mixing section 103. For example, for each color emitted by an array of LEDs, two LEDs may be utilized, one on each side of a center axis of the mixing section 103. Symmetrically firing LEDs on either side of a center axis of the mixing section 103 can create a symmetrical situation within the mixing section 103 that balances the near-field spatial uniformity. Asymmetrical LED firing can create a dark tunnel in the center of the output aperture of the mixing section. When the optical source 101 includes a plurality of colored LEDs, chromatic uniformity can be obtained by placing the same color LED on symmetric sides of the central axis. For example, matching numbers of white LEDs, amber LEDs, or green LEDs can be placed on either side of the central axis of the mixing section to improve spatial and/or color non-uniformity (e.g. one LED of each color may be provided on either side of the central axis). In contrast, an asymmetric arrangement of LEDs of different colors can cause visible far-field non-uniformity, which can manifest as a rainbow coloration. The spatial arrangement of the LEDs in the LED array can improve color uniformity as well as wavelength mixing efficiency such that a shorter length of the mixing section can be used.

The length of the collimating section 105 can be selected to provide light output with a certain degree of collimation. The length of the collimating section 105 can be selected to balance the degree of collimation with light losses due to absorption of light in the collimating section 105. The optical coupling system 102 is configured such that very little light or substantially no light is extracted from the outer surfaces this portion of the illumination system. The optical coupling system 102 is configured such that light emitted from the optical source 101 is coupled into the tapered light guide 107 with very high efficiency. For example, the optical coupling system 102 is configured such that between about 20% to about 95% of light emitted from the optical source 101 is coupled into the tapered light guide 107. For example, the optical coupling system 102 can be configured to couple between about 25% and about 85% of light emitted from the optical source 101 is coupled into the tapered light guide 107. As another example, the optical coupling system 102 can be configured to couple between about 35% and about 75% of light emitted from the optical source 101 is coupled into the tapered light guide 107. As yet another example, the optical coupling system 102 can be configured to couple between about 45% and about 65% of light emitted from the optical source 101 is coupled into the tapered light guide 107. As another example, the optical coupling system 102 can be configured to couple between about 50% and about 70% of light emitted from the optical source 101 is coupled into the tapered light guide 107.

In various implementations, at least 90% of the light emitted from the LEDs can be coupled into the light receiving surface of the optical coupling system 102. The coupling efficiency can be increase such that at least 95% of the light emitted from the LEDs is coupled into the optical coupling system 102 by placing an anti-reflection coating adjacent the light receiving surface of the optical coupling system 102. The coupling efficiency can be affected by the alignment of the LEDs with respect to the light receiving surface of the optical coupling system 102. For example, coupling efficiency can degrade if the gap between the output aperture of the optical source 101 and the input aperture of the light receiving surface of the optical coupling system 102 is greater than about 0.050 mm.

In various implementations, a fraction of the light coupled into the optical coupling system 102 can be lost during injection into the tapered light guide 107 due to material losses and/or Fresnel reflections. For example, in various implementations, about 80%-95% of the light coupled into the optical coupling system 102 can be injected into the tapered light guide 107 after accounting for material losses and/or losses resulting from Fresnel reflections. The efficiency of coupling light from the optical coupling system 102 to the tapered light guide 107 can decrease if the gap between the light output surface of the optical coupling system 102 and the light input edge of the tapered light guide 107 is greater than about 0.010 mm (e.g., about 0.05 mm). Misalignment between the optical coupling system 102 and the tapered light guide 107 can result in further decrease in the light coupling efficiency between the optical coupling system 102 and the tapered light guide 107.

The input aperture of the mixing section 103 is sized to receive substantially all the light emitted from the output aperture of the optical source 101 and coupled to the mixing section 103 across the air gap. Under preferable conditions, the air-gap is held to less than 0.05 mm and preferably to less than 0.01 mm. Under preferable conditions the alignment between the effective LED aperture and the optical coupling system's effective input aperture (e.g., its input edge) will be made as tightly matched as possible. It is preferable to overlap the aperture areas as perfectly as possible, or to assure that the aperture area of the LED aperture is slightly less than or in some cases, slightly larger than, the effective input aperture of the optical coupling system. For example, the input aperture can be sized to receive between about 40% to about 95% of the light emitted from the output aperture of the optical source 101 and coupled to the mixing section 103 across the air gap. Due to the presence of the air gap between the optical source 101 and the mixing section 103, light coupled into the light mixing section 103 can be pre-collimated by Snell's Law to +/−Sin⁻¹(1/n_{mixing}), n_{mixing} being the refractive index of the mixing section 103. As a result of angle compression arising from Snell's Law, light propagating in the mixing section 103 is confined within the mixing section 103 by total internal reflection, until it exits an aperture opposite the optical source 101.

The collimating section 105 of the optical coupling system 102 is optically coupled to the mixing section 103. The input aperture of the collimating section 105 is configured to receive substantially all the spatially mixed light output from the mixing section 103 in an angular range between about

$$\pm {θ}_{1} = \pm {sin}^{- 1} ( \frac{1}{{n}_{collimating}} )$$

with respect to a normal to the light input surface of the collimating section 105 is output at a narrower angle θ₂ from the light output surface of the mixing section 103 given by the equation (1) below:

d sin θ₁=D sin θ₂ (1),

wherein d is the width of the input edge of the collimating section 105, D is the width of the output edge of the collimating section 105 and n_{collimating} is the refractive index of the collimating section 105.

By virtue of the collimating section's etendue-preserving sidewall shape (described further) and expanded output aperture dimension D, the collimating section 105 collimates light in only the plane of the light output surface 108b of the tapered light guide 107. The orthogonal meridian of the collimating section 105 has no optical power but does contribute to the overall spatial mixing of spatially disorganized input light from the LED array.

The collimating section 105 can have the same thickness as that of the mixing section 103, but can widen according to boundary conditions imposed by the etendue-preserving Sine Law. In various implementations, the side walls of the collimating section 105 can be configured to have a shape such that etendue is preserved between the input aperture of the collimating section 105 and the output aperture of the collimating section 105. For example, the side walls of the collimating section 105 can be parabolic. The length (L) of the collimating section 105 can satisfy equation (2) below:

L=0.5(d+D)/tan θ₂ (2)

Equations (1) and (2) above can be used as the prevailing boundary conditions to determine the curvature of the side walls. The curvature of the side walls as determined from equations (1) and (2) is configured such that at every point along the length of the collimating section 102, light upon striking the side wall is redirected at a desired collimation angle. The length L of the collimating section 105, given by equation (2) above can be referred to as the ideal etendue-preserving length. In various implementations, the length of the collimating section can be truncated to some fraction of the ideal length, L, given by equation (2) above while other collimating section shape factors are unchanged. Truncating the length of the collimating section 105 can be advantageous when the collimation angle is small. Under this condition, the ideal length can be very long (for example, greater than 300 mm). Without any loss of generality, there are only very small sidewall slope changes after the length of the collimating section reaches about 50% or more (e.g., 60%, 70%, 80%, etc.) of its ideal length, L. Accordingly, truncating the length of the collimating section at a length greater than or equal to about 50% of the ideal etendue preserving length L may not adversely reduce the degree of collimation of light output from the collimating section. Thus, in some implementations, the length of the collimating section is about 50% or more (e.g., 60%, 70%, or 80%) of its ideal length, L.

Truncating the length of the collimating section can also reduce the width of the output aperture. For example, in an implementation of an optical coupling system 102 including a mixing section 103 and a collimating section 105, the output aperture is reduced to 40.34 mm from 50.53 mm when the length of the collimating section 105 is reduced to about ⅔ of the ideal etendue-preserving length, which was about 345 mm for this implementation.

Assuming that other shape factors (e.g., thickness, curvature of the sidewalls, etc.) remain the same, the amount of light transmitted by a collimating section 105 having a shorter length can be greater than a collimating section 105 having a longer length. This can be attributed to reduced absorption associated with shorter optical path length. Accordingly, a collimating section 105 having a shorter length can be advantageous over a collimating section 105 having a longer length. A collimating section 105 having a shorter length can have other advantages as well, such as, for example, compact size, light weight, decreased costs, etc.

Accordingly, it will be appreciated that a collimating section 105 having an ideal etendue-preserving length, L, may be configured to spatially mix and collimate light output from the optical source 101 such that light propagating through the tapered light guide 107 has reduced spatial and color non-uniformities. For example, light output from a collimating section 105 having a length equal to the ideal Etendue preserving length L given by equation (2) and propagating through the tapered light guide may not exhibit regions with substantially reduced brightness or intensity (e.g., regions with dark spots or tunnels). However, truncating the length of the collimating section 105 can reduce the spatial and color uniformity since the additional length of the collimating section 105 can provide some beneficial spatial mixing. Thus, in various implementations, as discussed herein, the truncated length of the collimating section 105 is selected such that spatial and/or color non-uniformity is not substantially reduced.

In various implementations, the collimating section 105 can be configured to preserve etendue from the input surface of the collimating section 105 to the output surface of the collimating section 105. However, in some implementations, the collimating section 105 can be configured to be non-etendue preserving. In non-etendue preserving implementations, the collimation angle can be determined from equation (1), but the curvature of the side wall need not satisfy the boundary conditions given by equations (1) and (2). For example, in various implementations, the side walls can be flat (or planar) that connect the input surface of the collimating section 105 to the output surface of the collimating section 105. A disadvantage of having flat (or planar) side walls is that some amount of light may not be collimated.

The optical coupling system 102 is configured such that substantially no light is extracted from the edges or outer surfaces of the mixing section 103 and the collimating section 105. Rather, the optical coupling system 102 is configured to convert light from the optical source 101 into spatially-mixed and collimated light, which is output into the light guide 107. Without any loss of generality, the optical coupling system 102 can be tilted with respect to the light input surface 108a of the tapered light guide 107 by an angle that is equal to or greater than the taper angle of the tapered guide as shown in FIG. 1C.

The mixing section 103 and the collimating section 105 can include an optically transmissive dielectric material having a refractive index greater than 1. For example, the mixing section 103 and the collimating section 105 can include materials such as PMMA, glass, polycarbonate, ZEONEX™, acrylic or any other optical grade polymeric material. Without any loss of generality, optical grade can include those optically transparent materials whose extinction coefficient at every wavelength in a certain wavelength range (e.g., wavelengths in the visible range) is less than about 7E-08, and preferably less than about 7E-09. While materials having higher extinction coefficients may be used, the amount of optical loss by absorption at greater optical path lengths and distances may be undesirable. In some implementations, the mixing section 103 and the collimating section 105 can include a dielectric material having refractive index n in the range between 1.3 and 1.7. In various implementations, the refractive index of the mixing section 103 (n_{mixing}) and the refractive index of the collimating section 105 (n_{collimating}) can be substantially equal such that a difference between n_{mixing} and n_{collimating} is less than 0.01. In various implementations, n_{collimating} and n_{guide} can be substantially equal such that a difference between n_{collimating} and n_{guide} is less than ±0.01.

In various implementations, the optical coupling system 102 can be solid such that the entire volume of the optical coupling system 102 includes one or more dielectric materials having refractive index greater than 1. In some implementations, the optical coupling system 102 can be hollow. For example, the mixing section 103 can be a hollow tube made of a dielectric material whose internal volume includes air or a material having a refractive index lower than the refractive index of the dielectric material. The optical coupling system 102 can be manufactured using methods such as molding, injection molding, casting, etc.

In various implementations of the optical coupling system 102, the light input surface of the mixing section 103, the output surface of the mixing section 103/collimating section 105 and/or the sidewalls of the collimating section 105 can be partially or completely covered with a reflective material such as silver, aluminum or enhanced specular reflector (ESR) films such as those distributed by 3M corporation, for example. Reflective material disposed adjacent to and surrounding the light input surface of the mixing section 103, the output surface of the mixing section 103/collimating section 105 and/or the sidewalls of the collimating section 105 of the optical coupling system 102 can reduce leakage of high angle light caused by failure of total internal reflection of light propagating through the optical coupling system 102. In various implementations, the reflective material may be separated from the coupling system medium by a small air gap, or may be attached adhesively using an optically clear adhesive polymer having substantially the same refractive index as the material of the mixing section 103 and/or the collimating section 105. For example, a difference in the refractive index of the adhesive and the material of the mixing section 103 and/or the collimating section 105 can be less than 0.01 in various implementations. In various implementations, the refractive index of the adhesive can be selected to reduce Fresnel reflections and increase transmission through the optical coupling system 102.

In various implementations, the optical coupling system 102 can be a monolithic optical component that includes a unitary body. In such implementations, the division between the mixing section 103 and the collimating section 105 is not physical but conceptual and used for the purposes of simulating or analyzing propagation of light through the optical coupling system 102. However, in other implementations, the mixing section 103 and the collimating section 105 can be physically distinct and the optical coupling system 102 can be manufactured by integrating the mixing section 103 and the collimating section 105 together.

FIG. 2A illustrates an example of an optical coupling system 102 including an etendue-preserving angle transformer 115 provided at the input end of the mixing section 103. FIG. 2B illustrates an example of an optical coupling system 102 including an etendue-preserving angle transformer 115 provided at the output end of the collimating section 105. The angle transformer 115 can provide out-of-plane angle expansion to increase the angular range over which light from the collimating section 105 is input into the tapered light guide 107 in a plane that is orthogonal to the plane of the light output surface 108b of the tapered light guide 107. For example, if the angular range over which light is coupled into the tapered light guide 107 without the angle transformer 115 by virtue of Snell's Law is +/−42 degrees, including the angle transformer 115 can increase the angular range over which light is coupled into the tapered light guide 107 to +/−46-degrees, which can be sufficient to allow the tapered light guide 107 to extract light earlier than it would be able to if the angular range over which light is coupled into the tapered light guide is +/−42-degrees. This out-of-plane angle increase can be used either alone or along with a lenticular array that is configured to increase the angular range over which light is coupled into the tapered light guide 107 as discussed below with reference to FIG. 3 to increase or maximize spatial uniformity along the tapered light guide's output aperture.

FIG. 3 illustrates an example of the tapered light guide 107 including a lenticular array 120 including a plurality of lens elements disposed adjacent the light input surface 108a of the tapered light guide 107. In various implementations, the lenticular array can be an optical film or layer including a plurality of lenses or lenslets. In various implementations, the lens elements of the lenticular array 120 are arranged with the apex of the lens elements facing outwards towards the direction of the incoming light such that the angular range of light coupled into the tapered light guide 107 can be increased to increase light extraction from the tapered light guide 107 through earlier than otherwise expected failure of total internal reflection. Anti-reflection coatings may be applied to the lenticular lens surface as a means of reducing Fresnel losses.

As discussed above, an object of this disclosure is to stagger multiple light guiding units (e.g., 100a and 100b) continuously. Referring to FIG. 1A-2, the multiple light guiding units (e.g., 100a and 100b) partially overlap with each other such that the inclined surface of the tapered light guide 107a of a first light guiding unit 100a rests over the optical coupling system 102b (including the mixing section 103b and the collimating section 105b) of the adjacent light guiding unit 100b. To achieve compact staggering of the light guides, in some implementations, the tapered light guides 107a and 107b can have identical taper angles and the optical coupling system 102a and 102b are tilted by an angle greater than or equal to the taper angle α of the tapered light guides 107a and 107b. In such implementations, the inclined surface 108c of the tapered light guides 107a and 107b can be configured to be reflective such that little to no light leaks out of the tapered light guides 107a and 107b into the optical coupling system over which it rests. The tapered light guide of one light guiding unit need not overlap with the tapered light guide of an adjacent light guiding unit. Accordingly, the tapered light guides of the plurality of light guiding units can be arranged sequentially such that light from the illumination system is emitted from a plurality of serially sequential tapered light guides. The various light guiding units can partially overlap each other such that the tapered light guides of the various light guiding units are coplanar so as to provide a linear luminaire capable of providing for example up to 1000 lumens or light per feet, or in some cases more.

FIG. 4 is a flowchart that illustrates an example of a method 400 of fabricating an illumination system including a plurality of partially overlapping light guiding units. The method includes providing a plurality of light guiding units (e.g., light guiding unit 100a and light guiding unit 100b, FIGS. 1A-1), each light guiding unit including an optical source (e.g., optical source 101), a tapered light guide (e.g., light guide 107) and an optical coupling system (e.g., optical coupling system 102), as illustrated in block 405. The method 400 further includes disposing the plurality of light guiding units (e.g., light guiding unit 100a and light guiding unit 100b) such that the tapered light guide (e.g., tapered light guide 107a) of one of the plurality of light guiding units (e.g., light guiding unit 100a) at least partially overlaps the optical coupling system (e.g., optical coupling system 102b) of an immediately adjacent light guiding unit (e.g., light guiding unit 100a), as shown in block 410. The plurality of partially overlapping light guiding units can be secured to one another, and/or to a frame holding the units in place. The units may be secured mechanically (e.g., by using hooks, clips, pins, screws, etc.) or using adhesives. Other methods of securing the plurality of partially overlapping light guiding units can also be used.

As discussed above, to facilitate the overlapping of the plurality of light guiding units (e.g., light guiding unit 100a and light guiding unit 100b), the optical coupling system (e.g., optical coupling system 102a) of each of the plurality of light guiding units can be disposed at an angle with respect to the light input edge of the corresponding tapered light guide (e.g., tapered light guide 107a). The angle at which the optical coupling system (e.g., optical coupling system 102a) of each of the plurality of light guiding units is disposed with respect to the light input edge of the corresponding tapered light guide (e.g., tapered light guide 107a) can be greater than or equal to the taper angle α of the tapered light guide.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower”, “above” and “below”, etc., are sometimes used for ease of describing the figures, and indicate relative positions corresponding to the orientation of the figure on a properly oriented page, and may not reflect the proper orientation of the structures described herein, as those structures are implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system comprising:
a plurality of partially overlapping light guiding units, each light guiding unit including:
a tapered light guide having a light input edge and an output surface disposed at an angle with the light input edge, a surface of the tapered light guide opposite the output surface being angled at a taper angle α with respect to the output surface;
an optical source; and
an optical coupling system for coupling light from the optical source into the light input edge,
wherein the tapered light guide of one of the plurality of light guiding units at least partially overlaps the optical coupling system of an immediately adjacent light guiding unit.

2. The system of claim 1, wherein the optical coupling system is disposed immediately adjacent the light input edge of the tapered light guide.

3. The system of claim 2, wherein the optical coupling system includes:
a light collimating section having a light input surface and a light output surface, the light collimating section configured to emit collimated light from the light output surface towards the light input edge of the tapered light guide, wherein side walls of the light collimating section between the light input surface and the light output surface are configured to collimate light in the plane of the output surface of the tapered light guide.

4. The system of claim 3, wherein the light collimating section is configured to preserve etendue of the light from the light input surface to the light output surface.

5. The system of claim 3, wherein the optical coupling system further includes:
a light mixing section having a refractive index (n), the light mixing section including a light receiving surface configured to receive light from the optical source and to couple light into the light collimating section.

6. The system of claim 5, wherein the optical source is separated from the light receiving surface of the light mixing section by a gap, wherein the gap comprises a material having lower refractive index than the refractive index (n) of the light mixing section.

7. The system of claim 5, wherein the light mixing section is a rectangular light pipe.

8. The system of claim 3, further comprising a lenticular array disposed between the light output surface of the collimating section and the light input edge of the tapered light guide.

9. The system of claim 1, wherein the optical source comprises a plurality of light emitting diodes.

10. The system of claim 1, further comprising one or more light extraction features disposed along the light output surface of the tapered light guide.

11. The system of claim 1, wherein the optical coupling system is angled with respect to the light input edge of the tapered light guide by an angle greater than or equal to the taper angle α.

12. A light guiding unit comprising:
a tapered light guide having a light input edge and an output surface disposed at an angle to the light input edge, a surface of the tapered light guide opposite the output surface being angled at a taper angle α with respect to the output surface; and
an optical coupling system including:
a light mixing section having a refractive index (n), the light mixing section including a light receiving surface configured to receive light from an optical source; and
a light collimating section having a light input surface and a light output surface, the light collimating section configured to receive light output from the light mixing section through the light input surface and emit collimated light towards the light input edge of the tapered light guide from the light output surface, wherein side walls of the light collimating section between the light input surface and the light output surface are configured to collimate light in the plane of the output surface of the tapered light guide.

13. The light guiding unit of claim 12, wherein the light collimating section is configured to preserve etendue of the light from the light input surface to the light output surface.

14. The light guiding unit of claim 12, wherein the optical source is spaced apart from the light receiving surface of the light mixing section by a gap, wherein the gap comprises a material having lower refractive index than the refractive index (n).

15. The light guiding unit of claim 12, wherein the light mixing section is a rectangular light pipe.

16. The light guiding unit of claim 12, wherein the optical source comprises a plurality of light emitting diodes.

17. The light guiding unit of claim 12, further comprising a lenticular array disposed between the light output surface of the collimating section and the light input edge of the tapered light guide.

18. The light guiding unit of claim 12, wherein the light mixing section has a length that is configured to spatially mix light emitted from the optical source.

19. The light guiding unit of claim 12, wherein the light mixing section has a length that is configured to angularly mix light emitted from the optical source.

20. A method of fabricating an illumination system, the method comprising:
providing a plurality of light guiding units, each light guiding unit including:
an optical source;
a tapered light guide having a light input edge and an output surface disposed at an angle with the light input edge, a surface of the tapered light guide opposite the output surface being angled at a taper angle α with respect to the output surface; and
an optical coupling system for coupling light into the light input edge; and
disposing the plurality of light guiding units such that the tapered light guide of one of the plurality of light guiding units at least partially overlaps the optical coupling system of an immediately adjacent light guiding unit.

21. The method of claim 20, further comprising disposing the optical coupling system at an angle with respect to the light input edge of the tapered light guide, the angle being greater than or equal to the taper angle α.

22. The method of claim 20, wherein the optical coupling system includes:
a light collimating section having a light input surface and a light output surface, the light collimating section configured to emit collimated light towards the light input edge of the tapered light guide from the light output surface, wherein side walls of the light collimating section between the light input surface and the light output surface are configured to collimate light in the plane of the output surface of the tapered light guide; and
a light mixing section having a refractive index (n), the light mixing section including a light receiving surface configured to receive light from the optical source and couple light into the light collimating section.
